(19) United States
(12) Patent Application Publication
(10) Pub. No.: US 2004/0030733 A1
(43) Pub. Date: Feb. 12, 2004

(54) Tile layout system, method and product

(76) Inventor: James M. Bell, Spartanburg, SC (US)

Correspondence Address: MILLIKEN & COMPANY, 920 MILLIKEN RD, PO BOX 1926, SPARTANBURG, SC, 29304, US

(21) Appl. No.: 10/628,674

(22) Filed: Jul. 28, 2003

Related U.S. Application Data
(60) Provisional application No. 60/399,771, filed on Jul. 31, 2002.

(51) Int. Cl. G06F 13/00

(52) U.S. Cl. 708/160

(57) ABSTRACT

A system and process is provided for computer-assisted calculation of the necessary number of carpet tiles needed to cover a given room. The process includes taking known dimensions of the carpet tile, and inputting relevant information with respect to room dimensions to be covered. Based upon the inputted information, the user is provided with information related to the number of tiles needed. The process aids in the efficient installation of tiles to reduce waste and improve appearance.

### CROSS-REFERENCE TO RELATED APPLICATIONS

This application claims the benefit of U.S. Provisional Application Serial No. 60/399,771 filed on Jul. 31, 2002, and which is incorporated herein by reference herein in its entirety.

### FIELD OF THE INVENTION

The present invention relates to flooring, flooring layouts, tile installations, carpet tiles, automated design systems, web based design systems, and/or the like.

### BACKGROUND OF THE INVENTION

Cushion back carpet products or carpet tiles are described for example in U.S. Pat. Nos. 4,522,857 and 6,203,881 each hereby incorporated by reference herein.

As described in commonly owned U.S. patent application Ser. No. 10/198,238, filed Jul. 18, 2002, entitled “Residential Carpet Product and Method” and Ser. No. 10/154,187, filed May 23, 2002, each hereby incorporated by reference herein, and as described in international application no. PCT/US02/22854, filed Jul. 18, 2002, hereby incorporated by reference herein, Milliken & Company of LaGrange, Ga. has developed a new, unexpected residential carpet tile product which substantially provides the look and feel of residential broadloom carpet over broadloom pad, while at the same time providing all of the benefits of modular carpet tile, such as do-it-yourself (D-I-Y) installation, cleanability, removability, replacement of extremely worn, soiled or damaged tiles, and/or the like.

The process of installing a residential tile carpet product is well within the skill level of many consumers. However, for many consumers, assistance with purchase requirements and job specific installation directions are desired in order to increase consumer confidence in one's ability to accurately purchase and install the product. Accordingly, there remains room for variation and improvement within the art.

### OBJECTS AND DESCRIPTION OF THE INVENTION

In accordance with at least one aspect of one embodiment of the present invention, in a carpet tile product such as Milliken® LEGATO™ residential modular product, each tile has a double-sided chevron shape which provides for the interlocking of adjacent tiles, helps in aligning adjacent tiles, serves to break up certain seams between tiles, forces the tiles to be installed with the process direction (tufting lines) of the adjacent, interlocked, tiles aligned, and/or the like. The process described herein provides for a computer-assisted calculation of the necessary number of carpet tiles while providing customized instructions regarding installation details for each purchase.

It is yet another aspect of at least one of the present embodiments of the invention to provide a computer-aided method of calculating the number of carpet tiles required for an installation project comprising the steps of: providing the dimensions of a carpet tile; inputting the dimensions of a room floor length and a room floor width to be covered; calculating the number of core carpet tiles needed; calculating the dimensions of a border region; calculating the number of carpet tiles needed to cover the border region; determining the total number of carpet tiles needed; determining the number of boxes of carpet tiles needed to provide at least the total number of carpet tiles; calculating at least one starting tile placement location for the room dimensions; displaying a location of at least one starting tile placement location within a scale drawing of the room; displaying the position for the remaining core carpet tiles within the scale drawing of the room; and, displaying the position of the tiles for the border region.

It is yet another aspect of at least one of the embodiments of the present invention to provide for a computer-assisted carpet tile product system and process which provides for product inventory needs and illustrates a specific carpet layout to ensure that any cut or edge border carpet tiles do not fall below a minimum size requirement for the particular carpet tile.

It is yet another aspect of at least one of the embodiments of the present invention to provide for a carpet tile product calculation process which adjusts the tile purchase requirements and recommended installation layout depending upon the parameters of the shape/size of the selected carpet tile and the room configuration and dimensions.

It is yet another aspect of at least one of the present embodiments of the invention to provide for a carpet tile selection process which provides a visual display or print out of a “to scale” room layout including the desired placement and location of a first tile, the subsequent location of the remaining core tiles, and the location of any “cut-to-fit” border tiles.

It is yet another aspect of at least one of the embodiments of the present invention to provide for a carpet tile product calculator system and process which automatically adjusts the number of tiles needed to provide a sufficient number of extra tiles to complete a given installation and provide replacement tiles for future use.

These and other features, aspects, and advantages of the present invention will become better understood with reference to the following description and appended claims.

### BRIEF DESCRIPTION OF THE DRAWINGS

A fully and enabling disclosure of the present invention, including the best mode thereof, to one of ordinary skill in the art, is set forth more particularly in the remainder of the specification, including reference to the accompanying drawings.

FIGS. 1-12 are respective illustrations in connection with a preferred, exemplary system, method or process in accordance with one preferred exemplary embodiment of the present invention.

FIG. 1 is a top view of a shaped tile showing the relevant parameters (dimensions) to be entered.

FIGS. 1A-1D are respective top view representations of selected tile configurations or shapes.

FIG. 2 is a top view representation of a room or installation area (floor) with certain parameters (dimensions) represented.

FIG. 3 is a top view illustration of a page layout with selected parameters or dimensions indicated.

FIG. 4 is a top view representation of graphical drawing functions in connection with a room tile layout.

FIGS. 5-12 are respective top view illustrations of exemplary room tile layouts, installation instructions, installation guides, tile counts, etc.

FIGS. 13A-13C are schematic, sequential top view installation instruction figures in connection with a particular tile installation method.

FIGS. 14-20 are schematic, representations of screen displays from an exemplary URL or web site in connection with the Milliken® LEGATO™ carpet system showing one preferred web based system incorporating the above described tile layout system, method or process in a very user friendly embodiment.

FIG. 14 represents a screen display of the home page or opening page.

FIG. 15 represents a screen display of the Project Center functionality or page with places for the user to input the room or area length and width. Once the information is input, the user can click on Calculate Estimate, Display Room Layout, or Clear Fields.

FIG. 16 represents a screen display with room data entry capability in accordance with a particular example.

FIG. 17 represents the screen display of the Calculate Estimate output for the particular data of FIG. 16. The system has calculated that 4 boxes of tiles are required for the particular installation (room). The system also provides information on the transition strips needed for the particular example.

FIG. 18 represents the screen display of the Display Room Layout for the particular example of FIG. 16. The room layout shows two alternative starting locations for the first full tile.

FIG. 19 represents a screen display with information on care and maintenance.

FIG. 20 represents a screen display with information on contacting the entity maintaining the web site.

### DESCRIPTION OF THE PREFERRED EMBODIMENT

Reference now will be made in detail to exemplary embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus or process pathway. To avoid redundancy, detailed descriptions of much of the apparatus once described in relation to a figure are not repeated in the descriptions of subsequent figures, although such apparatus or process is labeled with the same reference numbers.

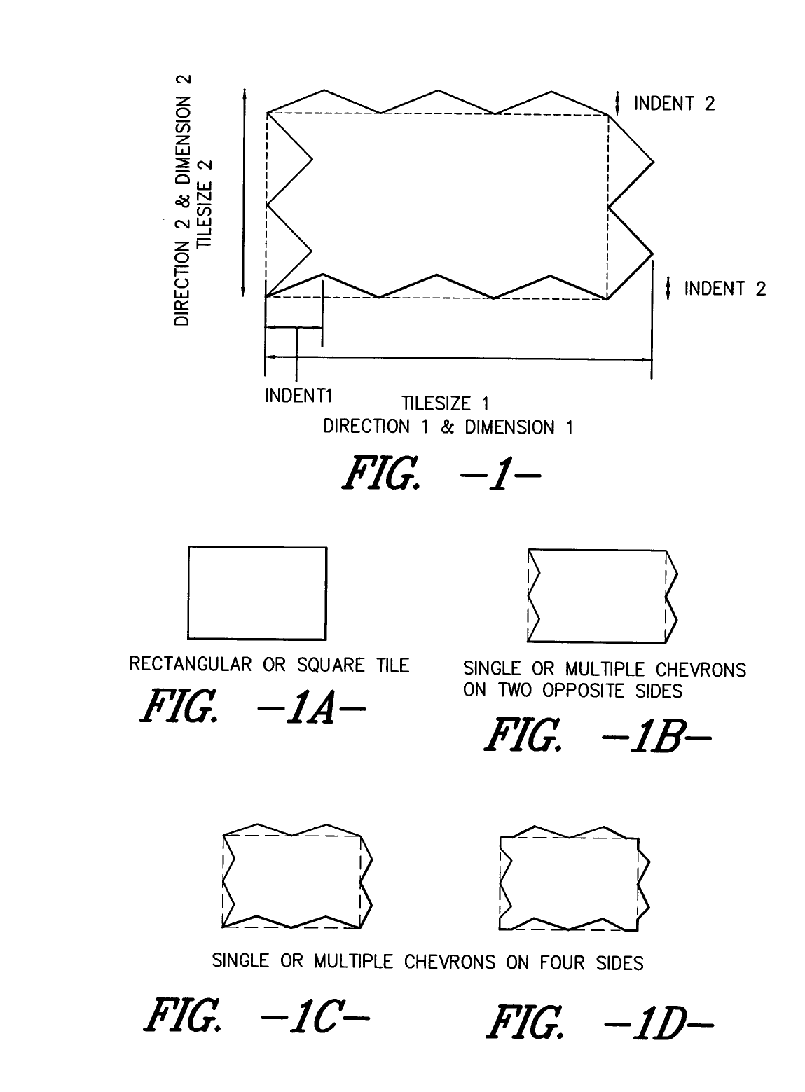

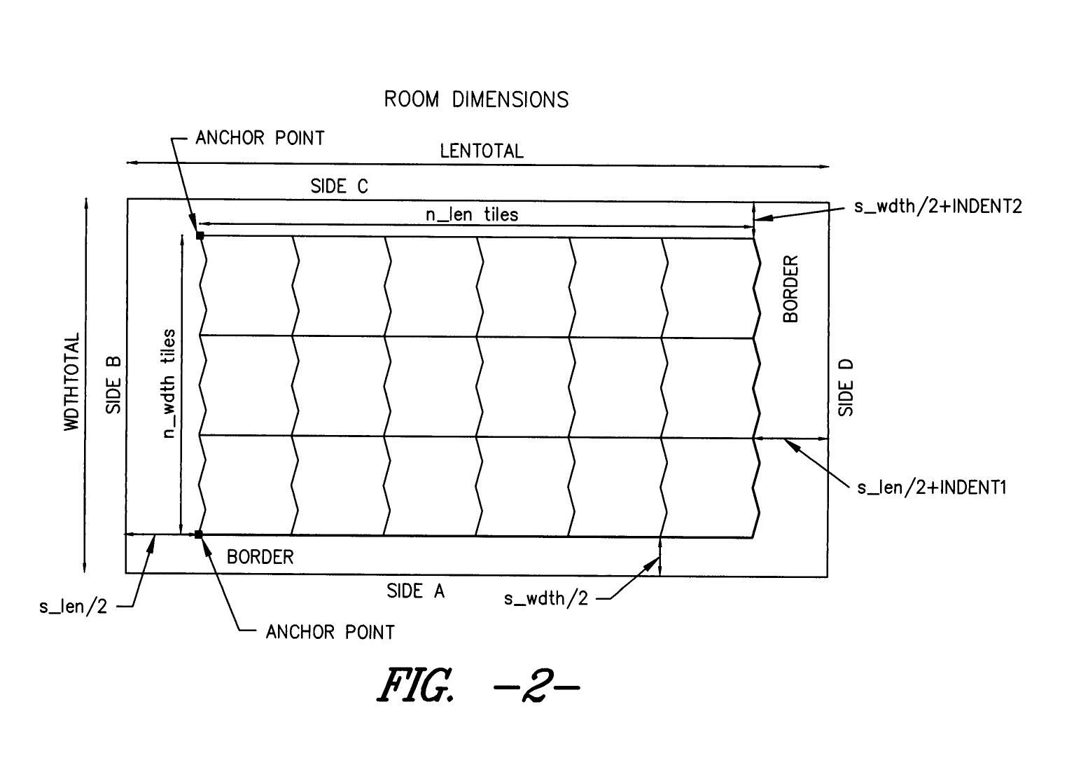

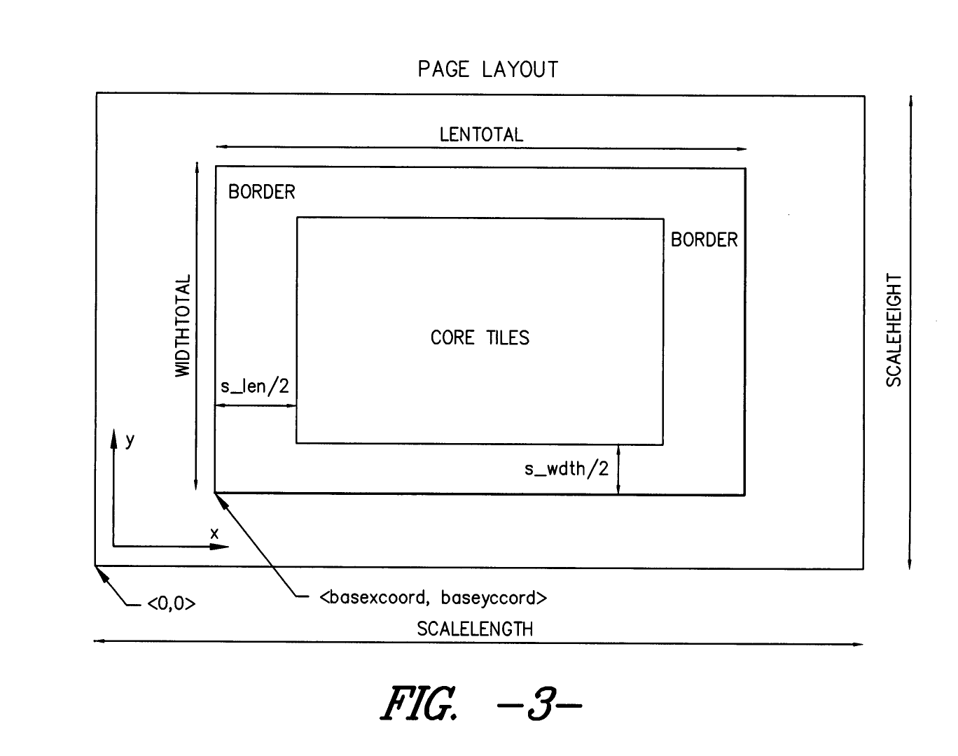

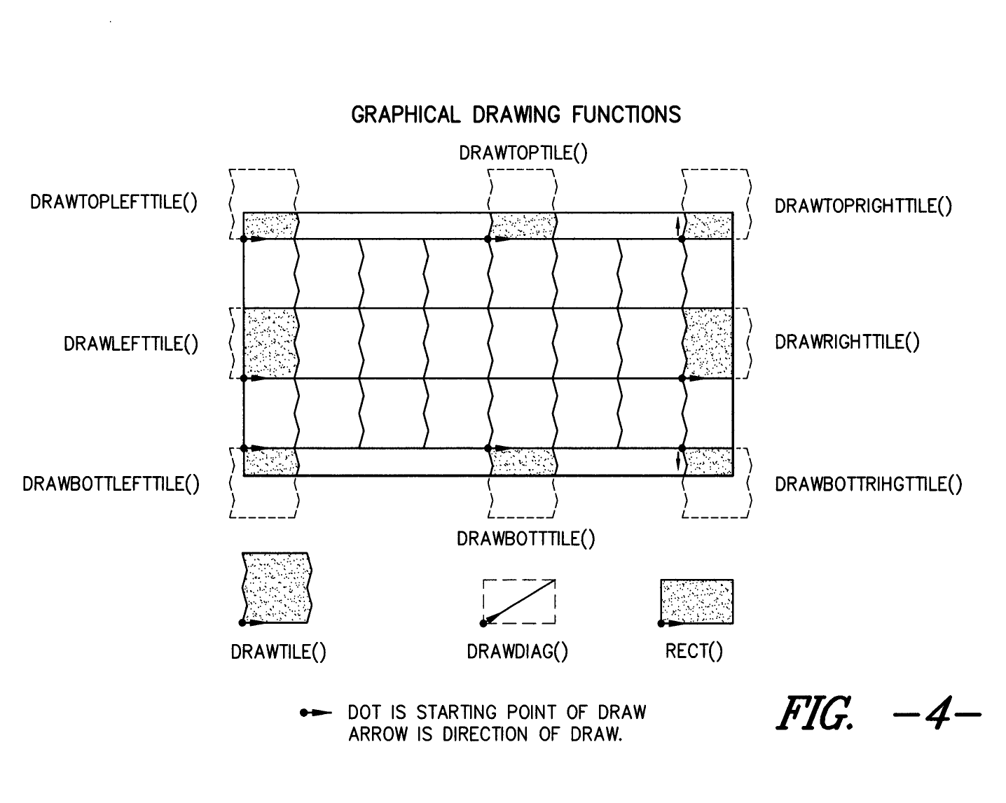

The double-sided chevron shape of the illustrated exemplary carpet tile (see FIG. 1B) has two protruding chevrons (convex elements or protrusions) on one edge of the tile, two indented chevrons (concave elements) that correspond with the protruding chevrons on the opposing edge of the tile. The remaining edges of the tile are parallel, straight sides.

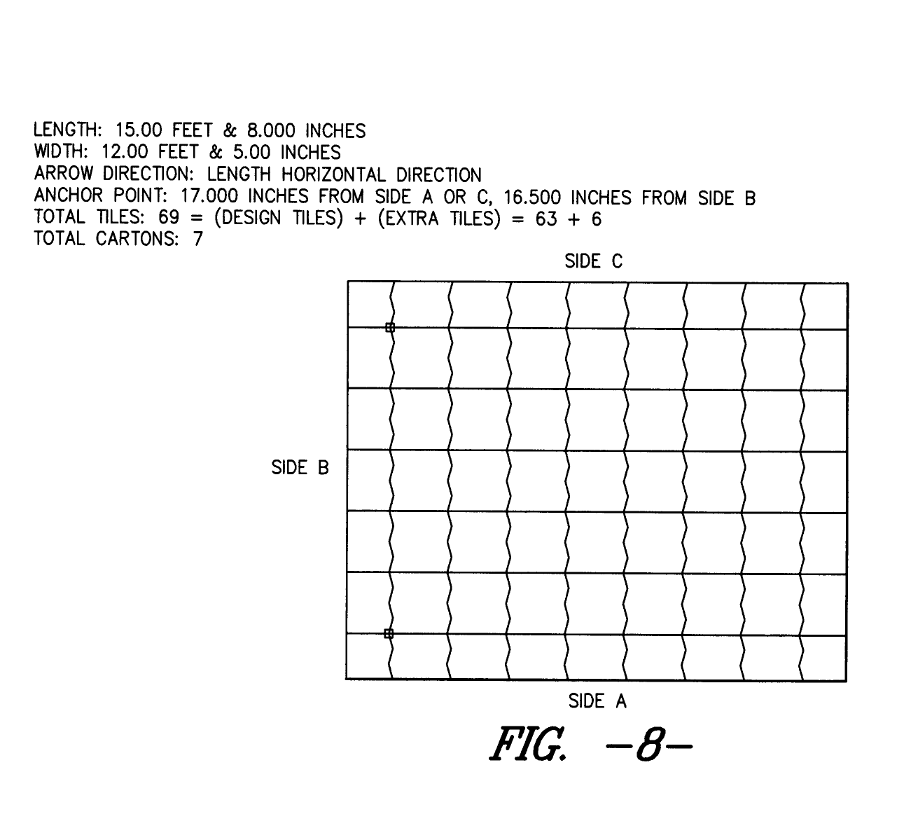

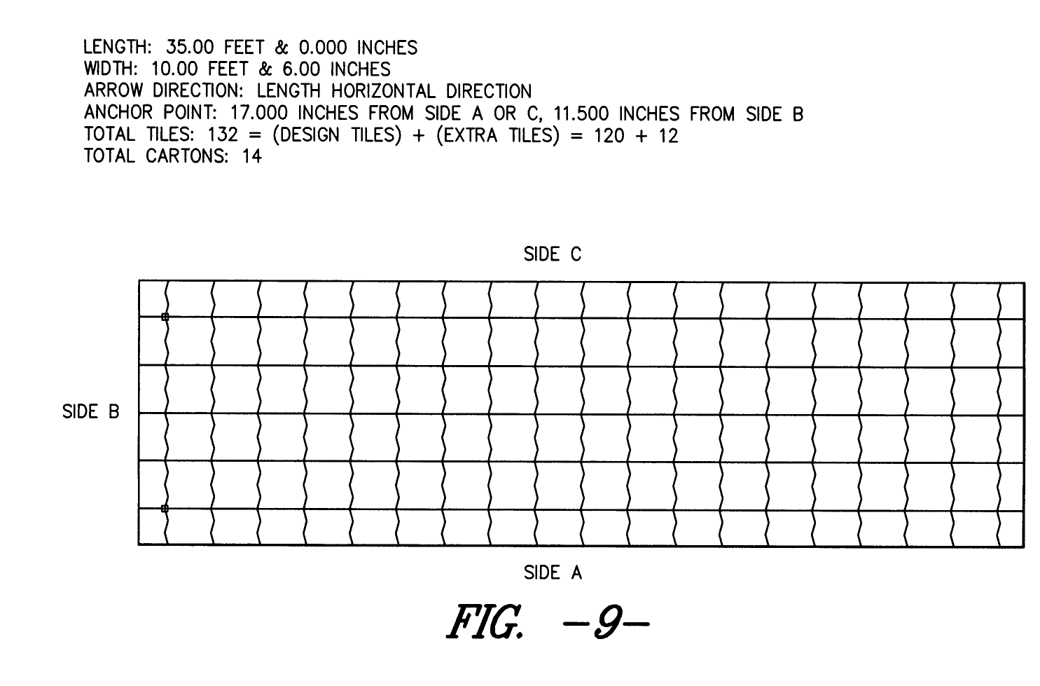

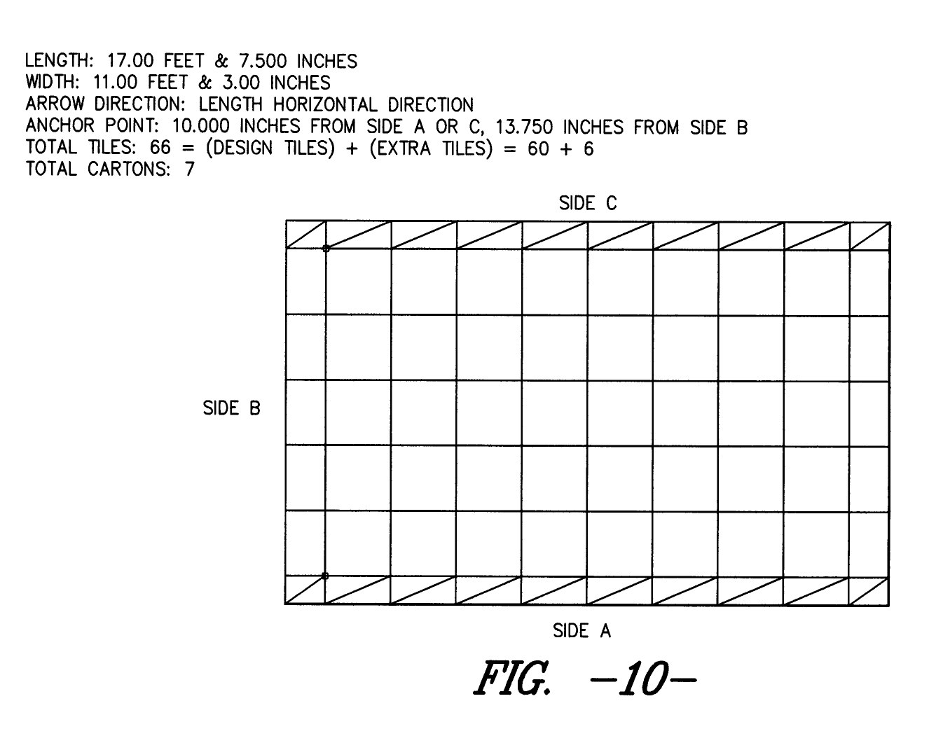

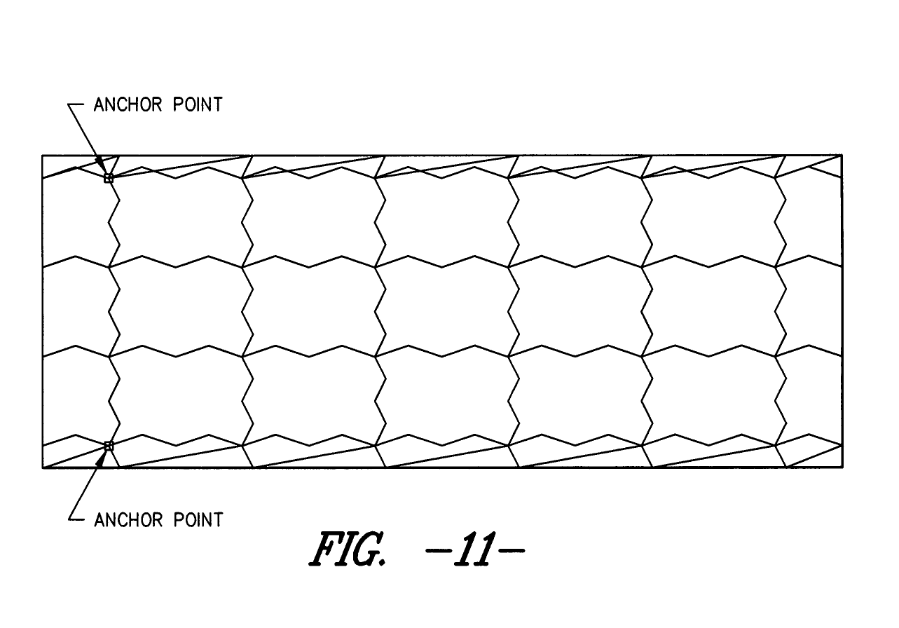

The protruding and indented chevron elements create an interesting development in tile installation not necessarily common with rectangular or square carpet tiles (see FIGS. 1A and 5-12).

In accordance with at least one embodiment of the present invention, it is contemplated that cut tile pieces or edge tiles have a sufficient width so that after installation, the edge pieces or tiles will stay adhered to the floor (sub floor), not tend to pull up, not delaminate, accommodate protruding or indented elements, and/or the like. By way of example only, and not limitation, this width is preferably at least about 4 inches and will more preferably be at least about 6 inches although greater or lesser widths may be used if desired. The present system automatically provides for a customized layout which maintains all cut tile pieces on edge tiles within the preferred size range.

A do-it-yourself installer, such as a homeowner, or a professional installer can install rectangular or square carpet tiles in a rectangular room in one of several ways. One may start at the center of the room (cross diagonal lines to find the center) and place a first tile with one corner on the center, place another tile adjacent the first with one corner at the center, and continue placing additional tiles in a clockwise or counter-clockwise direction until all of the full tiles have been placed and then cut tile pieces to finish out the edges of the room (monolithic installation). Alternatively, with rectangular or square tiles, one can start along a long, straight wall and place tiles along the wall and then place additional abutting tiles row by row or column by column until all of the full tiles are laid and the edges are finished out by cutting tile pieces (from full tiles). These two installation methods work reasonably well with rectangular or square tiles, but may require one to have edge pieces which are very thin, pointed, or the like. These two methods are more troublesome when it comes to installing a shaped tile (other than a rectangle or square) especially one having protruding and/or indented elements.

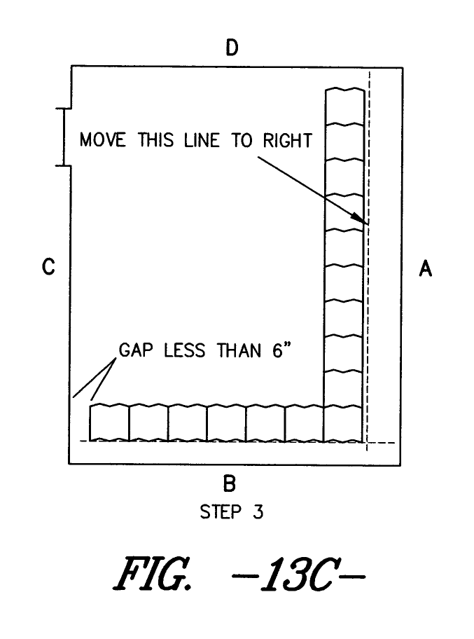

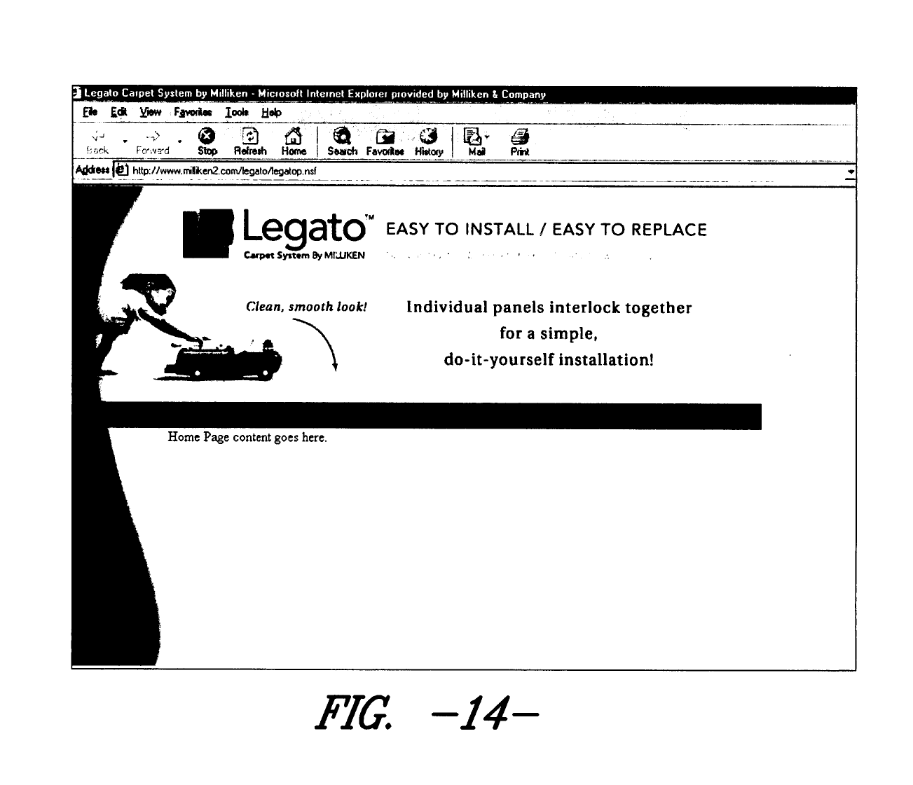

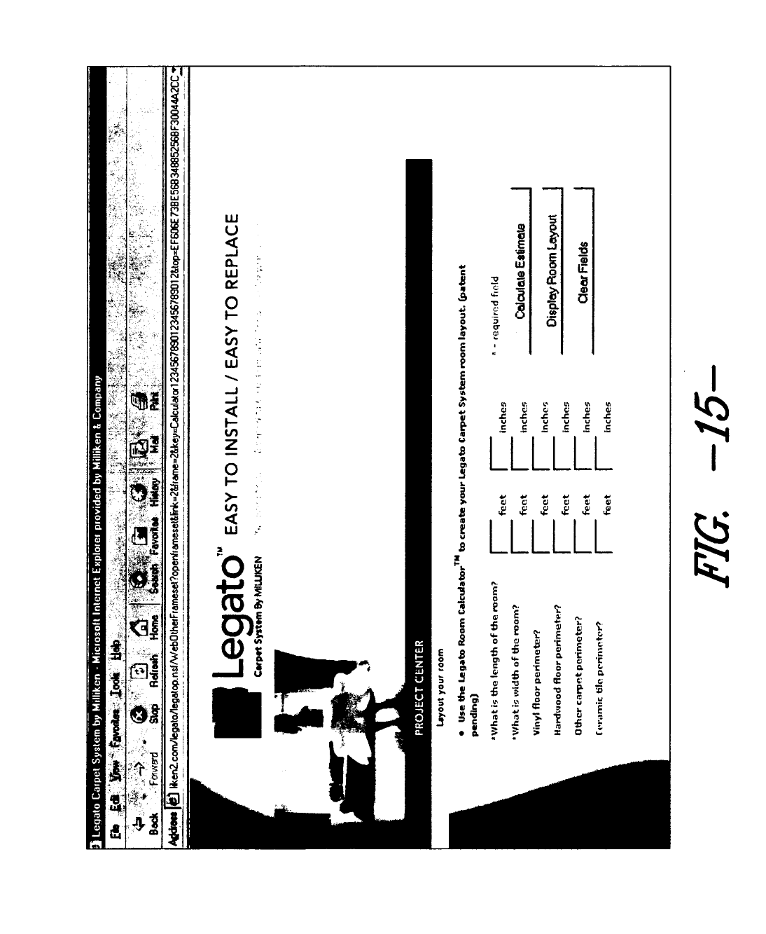

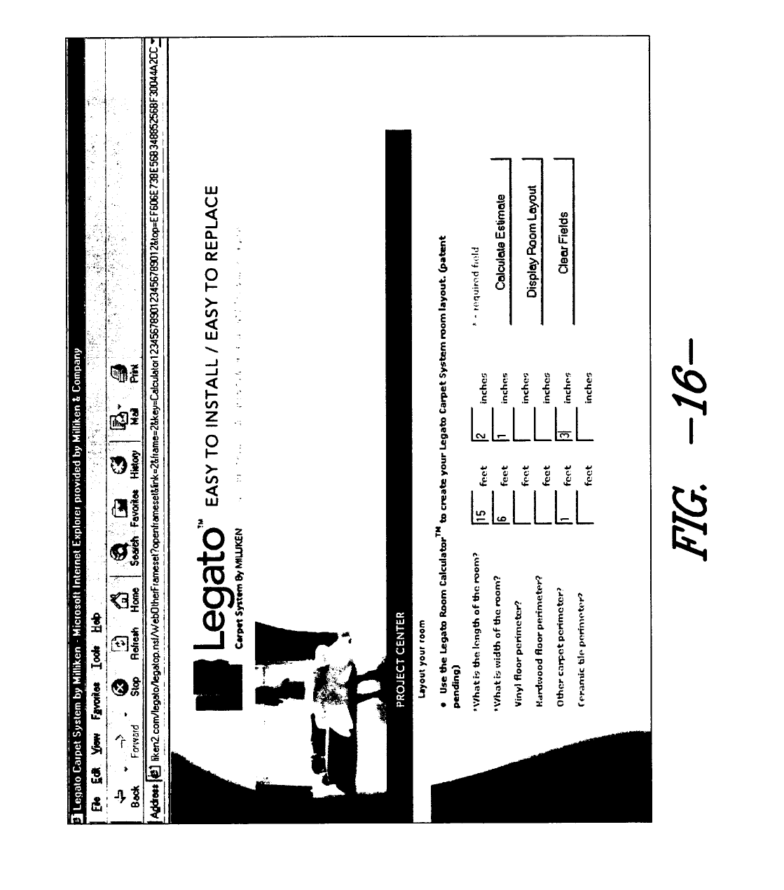

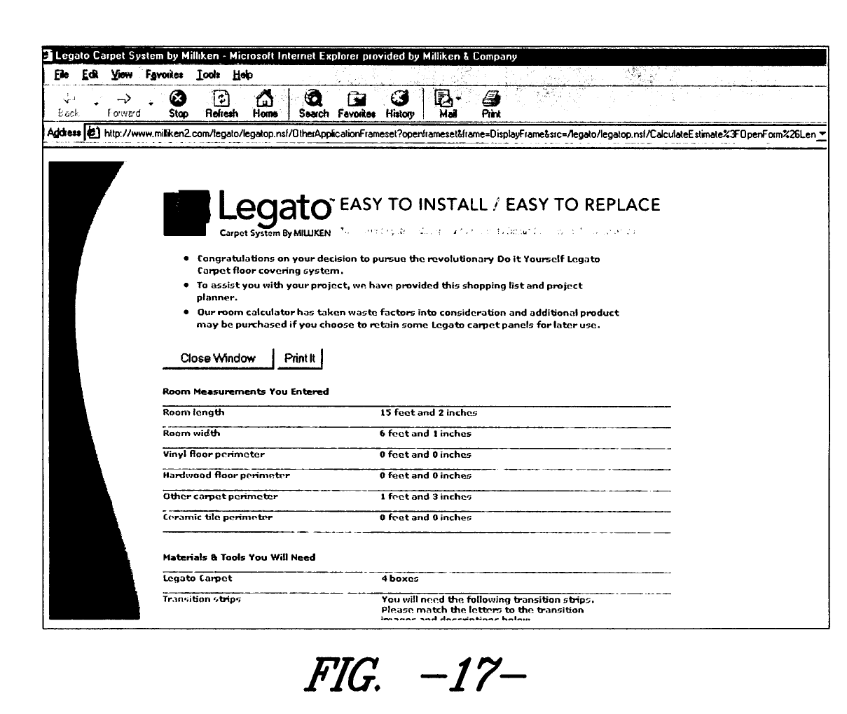

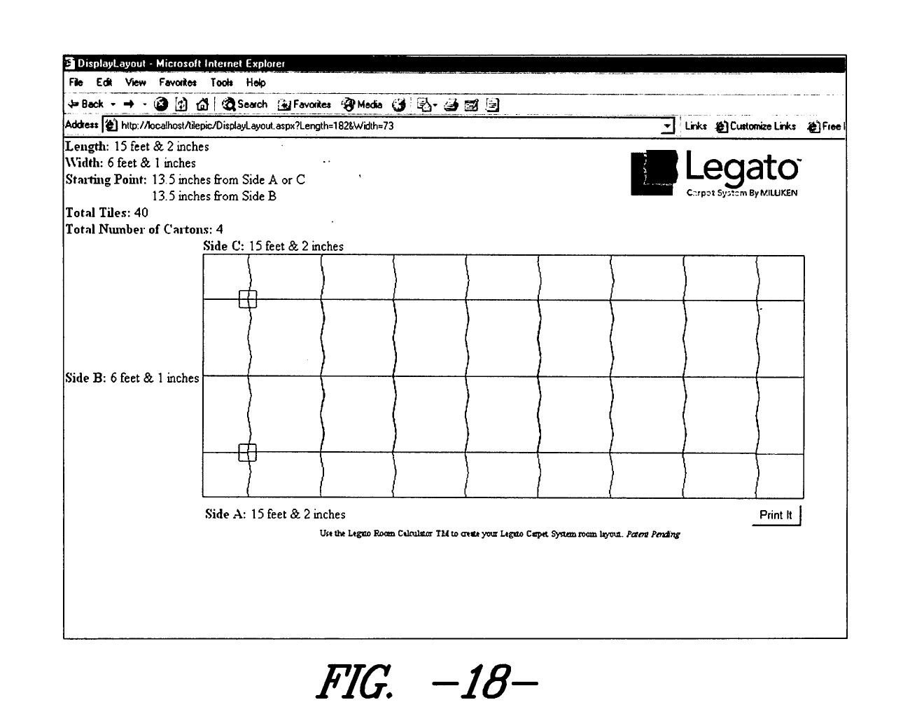

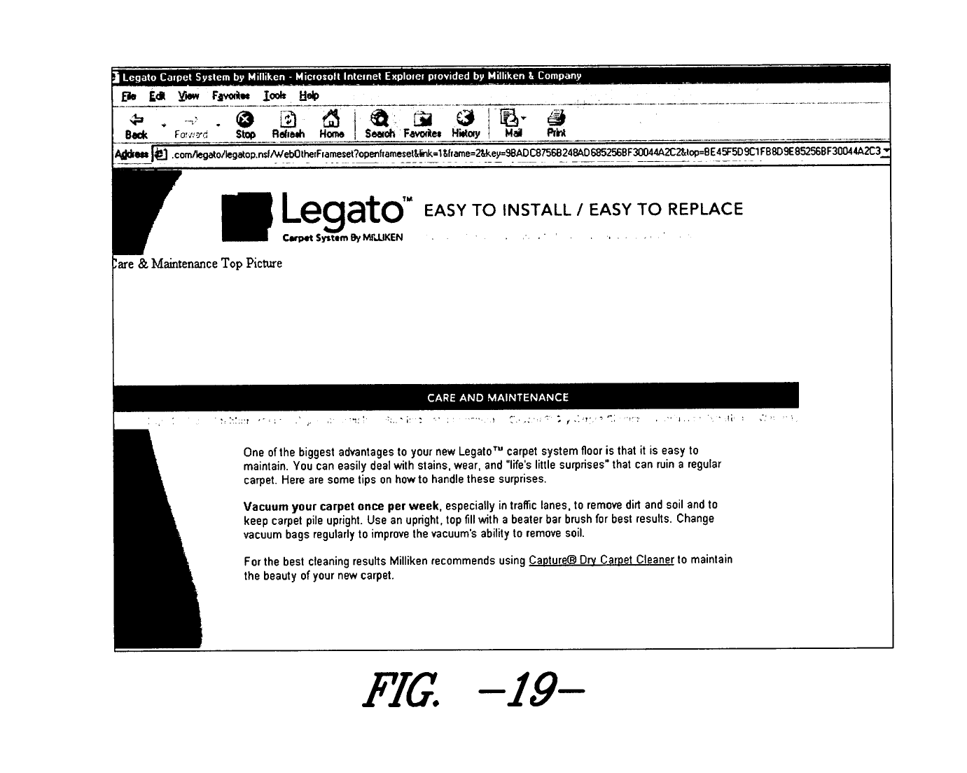

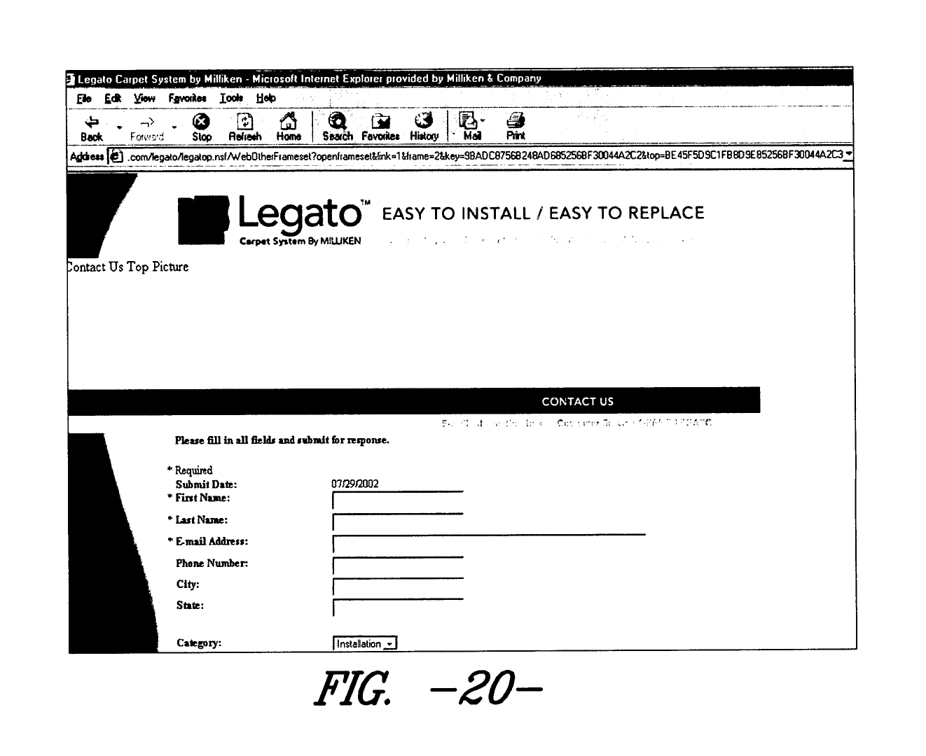

As shown in FIGS. 13A-13C of the drawings, the illustrated shaped residential tiles can be installed by starting a first row or column of non-adhered test tiles a selected distance away from two adjacent walls, for example, with a 23 inch×23 inch nominal sized, shaped tile having about 1 inch deep protrusions and indentations, starting about 12 inches from each of two walls, walls A and B, placing the entire row or column of full tiles along wall A and seeing if there exists a gap of less than a minimum predefined distance. Depending upon the distance of the gap the tile is left in place, moved towards the first wall or moved towards the second wall to achieve an acceptable gap width. By way of example only, according to one practice, if the predefined minimum gap distance is 6 inches, if the gap is less than this predefined distance, the first tile is moved closer than 12 inches toward the second wall, wall B, if the gap is greater than 6 inches but less than 12 inches the tiles are left in place, and if the gap is greater than 12 inches either the first tile is moved more than 12 inches from the second wall, wall B, (to try to even out the gaps at the walls, walls B and D, with each gap being over 6 inches and about equal) or the tiles may be left where they are (gap at one end about 12 inches, gap at other end over 12 inches).

Next, one lays a perpendicular row or column of non-adhered test tiles along wall B to see if a predefined minimum gap distance (ex. 6 inches) exists between the last full tile and the third wall, wall C. If the gap is less than 6 inches, moving the first tile closer to the first wall, wall A, and if the gap is over 6 inches either leaving the tile placement as is or trying to even out the gaps at walls A and C (about the same gap at each and over 6 inches). This trial and error method is time consuming but can provide an approximate starting point for the first full tile adjacent the first two walls, walls A and B. It is to be understood that the selection of the first two walls is not limited to walls A and B and that the tiles may be oriented rotated 90, 180, or 270 degrees from that shown.

As an alternative or improvement to the installation process or method shown in FIGS. 13A-13C and in accordance with at least one preferred exemplary embodiment of the present invention and with reference to FIGS. 1-12, a novel system, process or method for calculating exactly how many tiles are needed for the installation, exactly how the tiles should be laid out in the room subject to several constraints, and how many cartons of tiles (number of tiles) are needed for installation and other contingencies such as spoilage/replacement has been developed especially for use with a rectangular room or area to be covered with flooring such as carpet tiles. The method accounts for:

(1) The shape or geometry of the tiles.

(2) The rectangular dimensions of the room.

(3) Irregularities in the rectangular dimensions of the room.

(4) The splitting of tiles placed along the borders or edges so that one part of a border tile is used on one side of a room and the other part is used on the opposite side of the room. Those tiles that can be split are identified.

(5) Ensuring that the distance of any edge of a whole or full tile in the interior of the room from the edge of the room is never less than a minimum distance.

(6) The initial or anchor point of the installation (this point is the specific location in the room matched with a specific location on the initial full tile of the installation).

(7) The calculation of the number of extra tiles to allow for waste and spare replacement tiles. This calculation is based upon a rule that explicitly depends upon the exact number tiles needed for installation.

(8) The number of whole cartons of tiles, at a given number of tiles per carton, recommended for the installation.

One object or purpose of this method is to provide an explicit map or layout for installing tiles in a room. The layout identifies explicitly the placement of the first or initial whole tile that determines the placement of all other tiles, gives the number of tiles needed, and identifies what tiles may be split between borders.

The present invention addresses the problems of how many tiles are needed for an installation, how the tiles are to be placed in the room—especially how the initial whole tile (which determines the placement of all the other tiles) is placed.

Typical procedures for installing tiles involve (1) calculating the area of the room, (2) then calculating the number of tiles so that the total area of the tiles is at least that of the room, (3) including some extra tiles to account for irregularities of the room, spoilage, and tile geometry based upon the area of the room or the total number of tiles found in (2). The dependence upon tile geometry in typical procedures is based upon an empirical “rule of thumb”.

Since the exact number of tiles needed for an installation depends upon the shape or geometry of the tiles, the length and width dimensions of the room, and other installation requirements, the use of any method that depends upon the room and tile areas (and not upon the tile dimensions and shape, the room dimensions, and other constraints) will not reliably produce the exact number of tiles needed for an installation.

The present procedure explicitly takes into account chevron type asymmetries in the shape of the tiles, such as a chevron type tile, the dimensions of the room, a specific amount of irregularity in the rectangular room dimensions, and other installation constraints in giving an exact count of the number of tiles needed and a layout or map showing where the tiles are to be placed in the room. The number of extra tiles needed for spoilage and spares is calculated separately from the exact number of tiles needed for installation.

The tile map or layout and anchor point given by the present preferred procedure provide explicit instructions for installing the tiles. Without a map and anchor point, an installer may typically use the trial-and-error placement of the tiles as illustrated in the attached three FIGS. 13A-13C (Step1-Step3).

Layouts have been created for several rooms using the present method and the layouts have been used physically to tile these rooms (as installation instructions).

As described above with reference to FIGS. 13A-13C, one labor intensive, trial and error method for laying the tiles consists of provisionally laying chalk lines inset 1 foot from two adjacent room edges and then provisionally laying tile along these chalk lines. If the edges of the full tiles at the opposite ends are too close to the room edges, then, using trial-and-error, the chalk lines are to be moved to be sure of a minimum distance between full tiles and the edges of the room. In addition, the number of tiles recommended for the installation are based upon just the area of the room, the area of a tile, and a rule for spare tiles instead of upon the dimensional shape of the room, the geometric shape of a tile, and a rule depending on the actual number of tiles for the installation.

With reference again to FIGS. 1-12 and in accordance with one particular preferred embodiment of the present invention related to a preferably automated, computer assisted approach to tile layout and installation, the following parameters are defined:

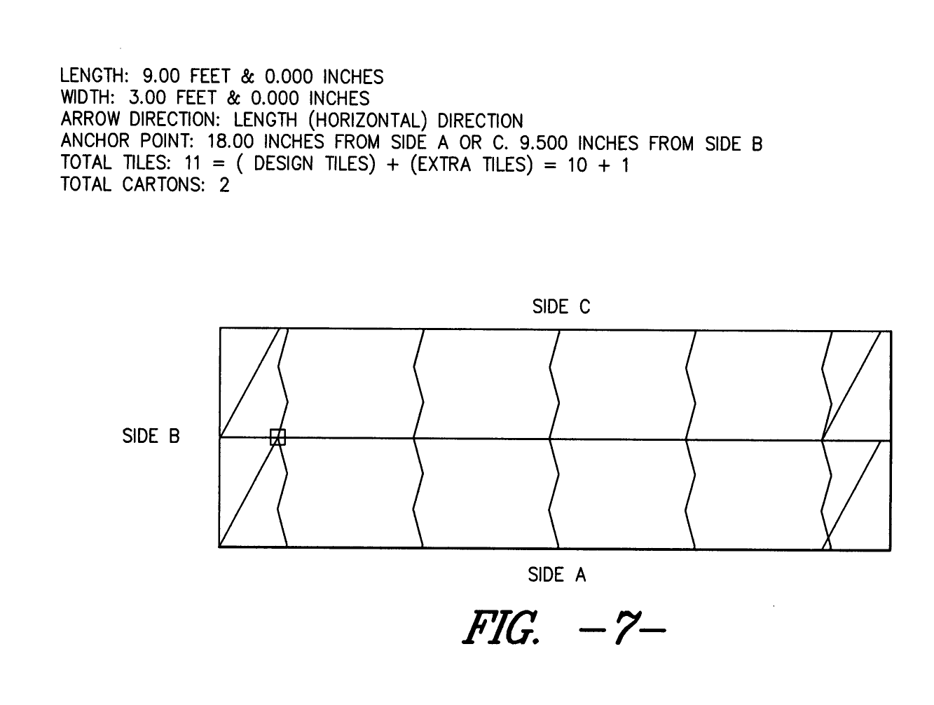

The specific values given for the following parameters are for illustrative purposes only and correspond to the examples given in FIGS. 5-9.

| | |
|---|---|
| TILESIZE1 = 23.0 | length in inches of dimension 1 of a tile |
| TILESIZE2 = 23.0 | length in inches of dimension 2 of a tile |
| INDENT1 = 1.0 | indentation in direction 1 for a tile |
| INDENT2 = 0.0 | indentation in direction 2 for a tile |
| MINBORDER = 6.0 | minimum width in inches of a border |
| DELTA = 3.0 | number of inches allowed to handle |
| | irregular room dimensions |
| TILES_PER_CARTON = 10 | number of tiles in a carton |
| EXTRA_TILES_PER_{—} | extra tiles per 100 tiles for waste, |
| 100 = 10 | replacements, etc. |
| INCHES_PER_FOOT = 12.0 | number of inches in a foot |

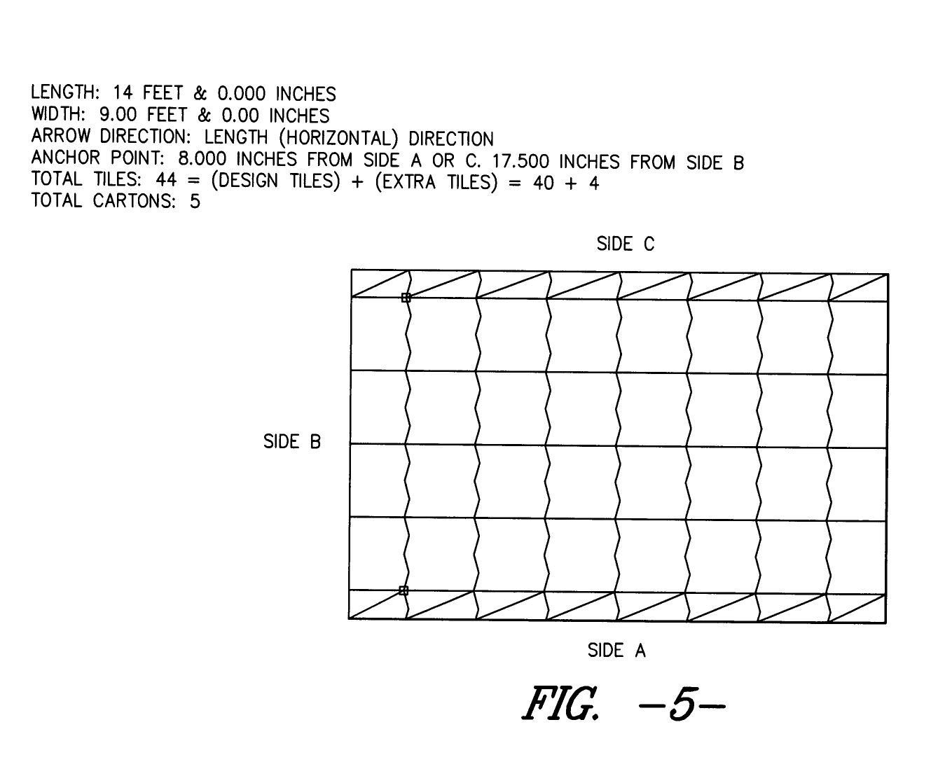

See FIGS. 1-1D for diagrams of tiles. See FIG. 2 for a diagram of a room that will be filled with tiles. Parts of tiles will be used in the border region. The units of distance could be any single linear measure (inches, feet, meters, etc.); but, for illustrative purposes, inches are used as the fundamental unit of linear measure in this discussion and in the examples. All length dimensions must be converted to the same linear unit for calculations. In the description of the method, tile direction 1 is assumed to be parallel to the length direction of the room and tile direction 2 is assumed to be parallel to the width direction of the room.

It is assumed for this discussion that the chevron-like features (if any) protrude to the right of the tile and/or protrude from the top of the tile. Every such protrusion has a corresponding indentation on the opposite side of the tile in order for the tiles to fit together. It is a trivial adaptation of the present method to accommodate cases for which the chevron-like protruding features are on opposite sides of a tile than depicted in FIG. 1.

The values acceptable for the parameters DELTA and MINBORDER are constrained by the tile size and geometry.

The method is capable of calculating and drawing the layout of rectangular or square tiles, of tiles with single or multiple chevrons on two opposite sides, and of tiles with single or multiple chevrons on four sides (see FIG. 1).

The preferred method includes the steps of:

(1) Obtain Dimensions of Room.

Obtain the dimensions of room in feet and inches and convert the dimensions to units of inches to give the following values:

lentotal=length of the longer dimension of the room (inches)

wdthtotal=length of the shorter dimension of the room (inches)

It is to be appreciated that by the term “room” is meant the dimensions of the floor area over which carpet coverage is desired. Thus, in the event that carpet is to cover only a portion of a floor space, the room dimensions are the dimensions of the portion to be covered which will be less than the total floor space available.

The requirement that lentotal>=wdthtotal is simply to ensure that the longer dimension of the room is oriented in the longer direction of the drawing medium and is not necessary for any essential element of the method.

(2) Calculate the Number of Core Tiles and the Dimensions of the Borders.

Note that the minimum border is MINBORDER inches.

n_len=number of whole tiles in the length direction

n_wdth=number of whole tiles in the width direction

s_len=number of inches left over in length direction after n_len whole tiles are used

s_wdth=number of inches left over in width direction after

n_wdth whole tiles are used

The respective borders have dimensions s_len/2.0 and s_wdth/2.0.

n_len and n_wdth are integer variables and s_len and s_wdth are floating point variables.

floor(x) is a function that returns the greatest integer k such that k<=x.

This calculation proceeds by ensuring that the borders are at least as wide as MINBORDER inches. Also the DELTA ensures that, even with irregular room dimensions, there will be at least the minimum border size.

(a) Handle Tiling in Length Direction.

```
  mm = floor((lentotal − INDENT1)/(TILESIZE1 −
INDENT1)) = whole number quotient
  rr = (lentotal − INDENT1) − mm*(TILESIZE1 − INDENT1)
= remainder
    [Note: 0 <= rr < TILESIZE1 − INDENT1]
  if (2*MINBORDER + DELTA <= rr)
  {
    n_len = mm
    s_len = rr;
  }
  else
  {
  n_len = mm − 1
  s_len = rr + TILESIZE1 − INDENT1
}
```

(b) Handle Tiling in Width Direction.

```
    mm = floor((wdthtotal − INDENT2)/(TILESIZE2 −
INDENT2))
      = whole number quotient
    rr = (wdthtotal − INDENT2) − mm*(TILESIZE2 −
  INDENT2) = remainder
      [Note: 0 <= rr < TILESIZE2 − INDENT2]
    if (2*MINBORDER + DELTA <= rr)
    {
      n_wdth = mm
      s_wdth = rr;
    }
    else
    {
      n_wdth = mm − 1
      s_wdth = rr + TILESIZE2 − INDENT2
    }
```

(3) Calculate the Total Number of Tiles Needed and the Indicators of Whether Border Tiles May be Split and Used in the Borders on Opposite Sid s of the Room.

num_tiles=number of tiles needed for layout (including extra for replacement, etc.)

tot_num_cartons=number of cartons of tiles for num_tiles tiles

can_split_len=indicator for whether tiles in border in the length direction can be split and used on opposite sides of the room. [1 means yes, 0 means no]

can_split_wdth=indicator for whether tiles in border in the width direction can be split and used on opposite sides of the room. [1 means yes, 0 means no]

```
if (s_len <= TILESIZE1 − INDENT1 − DELTA)
{
  can_split_len = 1
}
else
{
  can_split_len = 0
}
if (s_wdth < =TILESIZE2 − INDENT2 − DELTA)
{
  can_split_wdth = 1
}
else
{
  can_split_wdth = 0
}
```

If at least one pair of corner tiles can be split, then two tiles can cover the corners. If two pairs of corner tiles can be split, then, strictly speaking, a single tile can cover all four corners; however, in this case, to avoid excessive fragmentation of a tile, two tiles are used so that, in an installation, a tile needs to be split at most once.

```
if (can_split_len + can_split_wdth > 0)
{
  corner_tiles = 2
}
else
{
  corner_tiles = 4
}
```

The actual number of tiles needed for installation is

num_{—}tiles_{—}exact=n_{—}len*n_{—}wdth+(2−can_{—}split_{—}len)*n_{—}wdth+(2−can_{—}split_{—}wdth)*n_{—}len+corner_{—}tiles

The following function is an example of a rule that allows for extra tiles for replacement and spoilage. The given function allows for extra tiles at a given rate or at least one extra tile, whichever is greater.

extra_{—}tiles=MAX(1, EXTRA_{—}TILES_{—}PER_{—}100*(num_{—}tiles_{—}exact/100.0))

num_{—}tiles=num_{—}tiles_{—}exact+extra_{—}tiles

No truncation occurs in the following division.

ceil(x) is a function that calculates the least integer k such that x<=k.

tot_{—}num_{—}cartons=ceil(num_{—}tiles/tiles_{—}per_{—}carton)

(4) Calculate the Location of the Anchor Points.

Once the layout is calculated as described in Parts (1)-(3), any uniquely identifiable point on any specific tile and the location for that point of the tile in the room may be used as the starting point (anchor point) for an installation. The following method selects two such anchor points placed at opposite sides of the room in order to allow a choice.

The anchor points <xanchor1, yanchor1> and <xanchor2, yanchor2> are the coordinates of two starting points for laying the tiles as located near the corner of Sides A&B and the corner of Sides B&C, respectively (see FIGS. 2 & 3).

The corner of Sides A & B anchor point <xanchor1, yanchor1>is located

s_wdth/2.0 inches from Side A

s_len/2.0 inches from Side B

The corner of Sides B & C anchor point <xanchor2, yanchor2> is located

s_wdth/2.0+INDENT2 inches from Side C

s_len/2.0 inches from Side B

(5) Set Up to Draw the Tile Layout for the Room

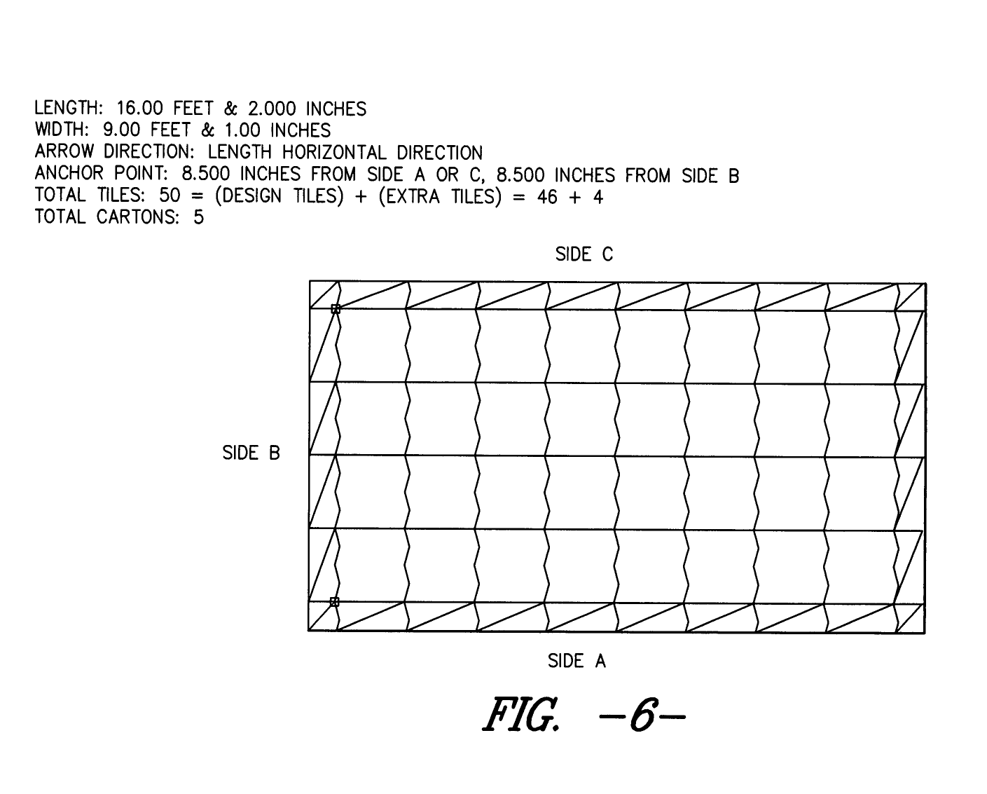

FIG. 3 shows the relationship of the room, the tiling information, and the drawing page.

It is assumed that the following primitive drawing functions are available for the media for which the drawing is being done. Their implementation is system specific.

```
penup( )
  Raise the drawing pen.
pendown( )
  Lower the drawing pen for drawing.
moverel(deltax, deltay)
```

From the present pen position, move deltax units in the x-direction and deltay units in the y-direction.

moveabs(x, y)
Move the pen to the location <x,y>

A move with the pen down draws a line. A move with the pen up does not draw a line.

There may be other primitives necessary for initializing and terminating the drawing. In particular, in my implementation, the dimensions of the writable page are (see FIG. 3)

scalelength=size of the page in horizontal (i.e., x-) direction (in physical units of objects being drawn)

scaleheight=size of the page in vertical (i.e., y-) direction (in physical units of objects being drawn)

The length direction of the page is set to the length dimension direction of the room, and the height direction of the page is synonymous with the width direction of the room.

```
Choose ratios
  RATIO1 >= 1
  RATIO2 >= 1
  RATIO3 >= 1
if (lentotal/wdthtotal >= RATIO1)
{
  scalelength = lentotal * RATIO2
  scaleheight = scalelength * (1/RATIO1)
}
else
{
  scaleheight = wdthtotal * RATIO3
  scalelength = scaleheight * RATIO1
}
```

RATIO1 is related to the ratio of the longer dimension of the medium upon which the drawing is made to the shorter dimension. Although any RATIO1>=1 is acceptable, a ratio that approximates the ratio of the longer dimension of the medium upon which the drawing is made to the shorter dimension may be more esthetically appealing. Thus, RATIO1=11.0/8.5 may be appropriate for standard letter size paper. RATIO2 and RATIO3 are related to how much of the length or width of the medium is used by the drawing of the tiled room. In any case, these ratios may be adjusted to suit the situation at hand.

The coordinate system is set up as follows:

xbase=basexcoord=(scalelength−lentotal)/2.0

ybase=baseycoord=(scaleheight−wdthtotal)/2.0

roomlength=lentotal

roomheight=wdthtotal

Other drawing functions that are specific to the tile layout situation and that may be written in terms of the above primitives are given next. Examples of shapes that are drawn by the drawing functions and how the functions may traverse the figures are illustrated in FIG. 4. FIG. 4 gives a possible starting point and a suggested direction of traverse of the figure being drawn by each function. The details of the implementation of the drawing functions depend upon the actual shape of a tile.

```
rect( )
  Draws a rectangle
drawdiag( )
  Draws a diagonal for a rectangle
drawtile( )
  Draws a tile
drawlefttile( )
```

Draws the boundary of the intersection of the border region with a tile placed at the left of the room. The shaded region of FIG. 4 is the region whose boundary is drawn.

drawrighttile( )

Draws the boundary of the intersection of the border region with a tile placed at the right of the room. The shaded region of FIG. 4 is the region whose boundary is drawn.

drawtoptile( )

Draws the boundary of the intersection of the border region with a tile placed at the top of the room. The shaded region of FIG. 4 is the region whose boundary is drawn.

drawbotttile( )

Draws the boundary of the intersection of the border region with a tile placed at the bottom of the room. The shaded region of FIG. 4 is the region whose boundary is drawn.

drawtoplefttile( )

Draws the boundary of the intersection of the border region with a tile placed at the top left corner of the room. The shaded region of FIG. 4 is the region whose boundary is drawn.

drawtoprighttile( )

Draws the boundary of the intersection of the border region with a tile placed at the top right corner of the room. The shaded region of FIG. 4 is the region whose boundary is drawn.

drawbottlefttile( )

Draws the boundary of the intersection of the border region with a tile placed at the bottom left corner of the room. The shaded region of FIG. 4 is the region whose boundary is drawn.

drawbottrighttile( )

Draws the boundary of the intersection of the border region with a tile placed at the bottom right corner of the room. The shaded region of FIG. 4 is the region whose boundary is drawn.

The drawing coordinates of two anchor points are calculated as follows:

xanchor1=xbase+s_len/2.0

yanchor1=ybase+s_{—}wdth/2.0

xanchor2=xbase+s_{—}len/2.0

yanchor2=ybase+s_{—}wdth/2.0+n_{—}width*(TILESIZE2−INDENT2)

(6) Method for Drawing the Layout

FIGS. 2, 3, and 4, the calculations of Parts (1) through (4), and the drawing functions in Part (5) are used to produce a graphical representation of the tile layout.

Note that if a tile is to be split and used on opposite sides of the room, then, in this implementation, a diagonal line is drawn through that tile to indicate that it should be split. If no diagonal line is drawn through a tile, then the entire tile must be used on one side only with the trimmed part being wasted. Any other method of identifying whether a tile is split could be used.

FIGS. 5 through 10 are examples of the tile layouts produced by a particular implementation of the method described here. FIG. 10 is an example of a tiling with square tiles.

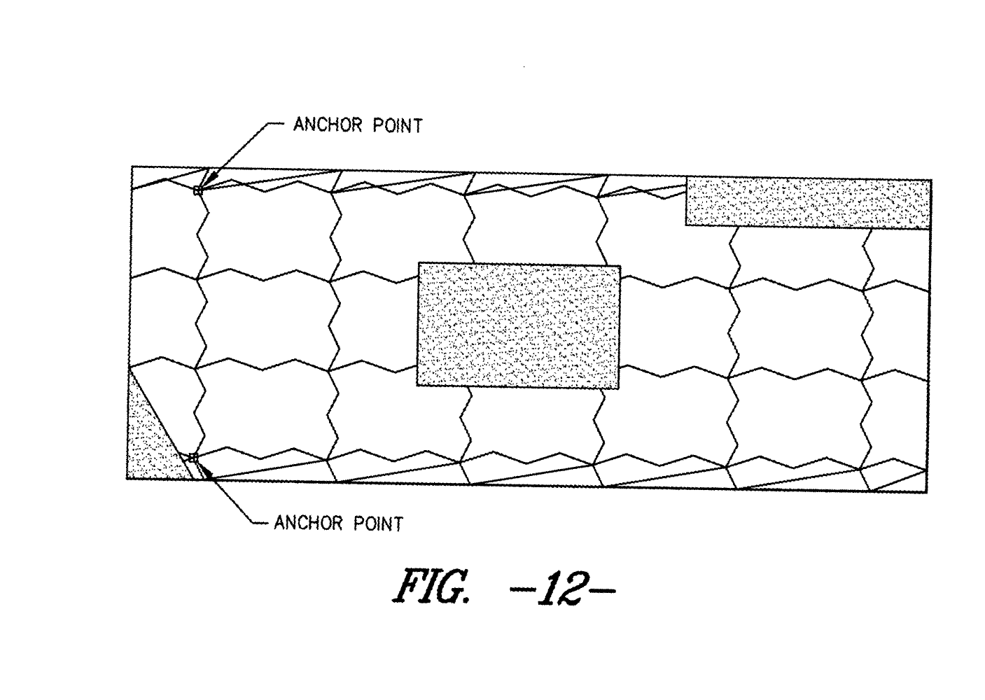

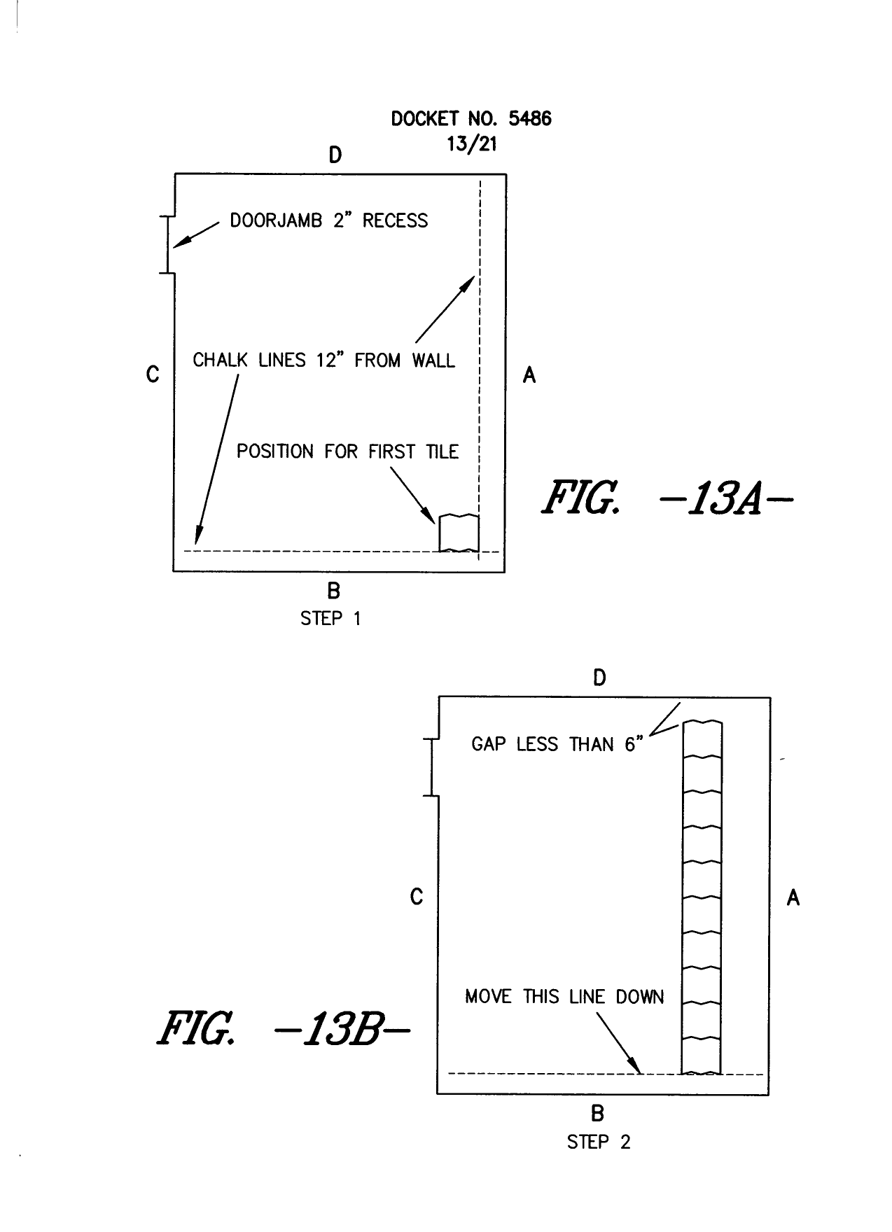

FIG. 11 is a layout of tiles with multiple chevrons on four sides. FIG. 12 illustrates how to determine the number of tiles to use for a rectangular room having objects that occupy positions not requiring tiling (examples of such objects are a corner cupboard, a fireplace that protrudes into the room, an isolated island, and the like). One would (1) generate a graphical drawing of the tile layout according to the rectangular room dimensions using the above method and (2) draw upon it the shapes the objects occupy on the floor of the room at the appropriate locations. The exact number of tiles needed to tile the room with the objects in place would be the exact number calculated by the method for the rectangular room (num_tiles_exact) minus the number of whole tiles that are completely covered by the objects.

FIGS. 5-12 represent respective tile layouts or installation instructions produced by the above-described method or system.

It is preferred that the present system or method be provided to customers, installers, dealers, retailers, and/or the like via the Internet or World Wide Web such as provided on a URL or web site, on floppy disk, on CD, DVD, or the like.

This system or method can be used by a residential or commercial carpet tile customer, contractor, dealer, retailer, installer, or the like to produce a room tile layout and installation instruction or guide.

In accordance with one preferred embodiment, the method or system is embodied in a computer program which performs the above-described method steps given the requested inputs, responses, criteria, etc. by the user and produces a room tile layout, installation instructions, installation guide, purchasing guide (how many tiles), or the like on a screen display, file output, hard copy printout, and/or the like.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, both in whole or in part. Therefore, the spirit and scope of the appended claims should not be limited to the description of the preferred versions contained therein.

What is claimed is:

1. A computer-aided process of calculating the number of carpet tiles required for an installation project comprising the steps of:
providing the dimensions of a carpet tile;
inputting the dimensions of a room floor length and a room floor width; and
calculating the total number of carpet tiles needed.

2. The process of claim 1, wherein the carpet tiles are non-rectangular.

3. The process of claim 1, further comprising the step of calculating the dimensions of a border region to be covered by fractional tile segments, wherein said fractional tile segments are included in the calculation of the total number of carpet tiles needed.

4. The process of claim 1, further comprising determining the number of boxes of carpet tiles needed to provide at least the total number of carpet tiles.

5. The process of claim 1, further comprising calculating at least one starting tile placement location for said room dimensions.

6. The process of claim 5, further comprising displaying a location of said at least one starting tile placement location within a scale drawing of said room.

7. The process of claim 6, further comprising displaying the position for the remaining carpet tiles within said scale drawing of said room.

8. The process according to claim 1 wherein said carpet tile dimensions further define carpet tiles having at least one protrusion on one edge of the tile and at least one corresponding indentation on an opposing edge of the carpet tile.

9. The process according to claim 1 wherein said carpet tile dimensions further define rectangular carpet tiles.

10. The process according to claim 1 wherein said carpet tiles are cushion-backed carpet tiles.

11. The process according to claim 1 wherein said step of determining the total number of carpet tiles needed additionally includes adding a sufficient number of additional tiles so as to include a calculated number of replacement tiles within said total number of carpet tiles.

12. A process of providing customized instructions for installation of a carpet tile product comprising the steps of:
providing dimensions of a selected carpet tile product;
providing dimensions of a length and a width of an installation area;
calculating an anchor point location for placement of an initial tile;
such that when said initial tile is placed at said anchor point, placement of additional carpet tiles is carried out such that a predefined minimum tile width is maintained throughout the installation.

13. The process according to claim 12, wherein said step of calculating an anchor point location additionally includes providing a visual display of said anchor point within a scaled diagram of said installation area.

14. The process according to claim 13, wherein said visual display of said anchor point additionally includes a display of locations for a plurality of core carpet tiles.

15. The process according to claim 14 wherein said visual display of said anchor point additionally includes a display of locations for a plurality of border carpet tiles.

16. The process according to claim 12, wherein said step of calculating an anchor point location includes providing distance coordinates relative to a length edge and width edge of said installation area.

17. The process according to claim 12, wherein said carpet tile product defines a plurality of carpet tiles, each said tile having at least one protrusion on one edge of the carpet tile and at least one corresponding indentation on an opposing edge of the carpet tile.

18. The process according to claim 12, wherein said carpet tile products further define a plurality of rectangular carpet tiles.

19. The process according to claim 12, wherein said carpet tile products further define carpet tiles having a cushioned backing.

20. The process according to claim 12, further including use of an identifier to indicate border carpet tiles which are to be split and used on opposite sides of said installation area.

21. The process according to claim 12, wherein the process includes the additional step of determining the total number of carpet tiles needed to cover said installation area.

22. A computer-aided method of calculating the number of carpet tiles required for an installation project comprising the steps of:
providing the dimensions of a non-rectangular carpet tile;
inputting the dimensions of a room floor length and a room floor width;
calculating the number of core carpet tiles needed;
calculating the dimensions of a border region;
calculating the number of carpet tiles needed to cover the border region;
determining the total number of carpet tiles needed;
calculating at least one starting tile placement location for said room dimensions;
displaying a location of said at least one starting tile placement location within a scale drawing of said room;
displaying the position for the remaining core carpet tiles within said scale drawing of said room; and,
displaying the position of the tiles for said border region.

23. An internet-based system for use in calculating the number of carpet tiles required for an installation project, the system comprising:
a registry holding dimensions of at least one carpet tile construction;
an input screen for entry of the dimensions of a room floor length and a room floor width by a remote user; and
a programmed processor adapted to calculate the total number of carpet tiles needed.
